(19) United States
(12) Patent Application Publication
(10) Pub. No.: US 2006/0284827 A1
(43) Pub. Date: Dec. 21, 2006

(54) Liquid crystal display and brightness enhancement film therefor

(75) Inventors: Soo-Im Jeong, Suwon-si (KR); Yong-Taek Hwang, Cheonan-si (KR); An-Na Park, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/471,745

(22) Filed: Jun. 20, 2006

(30) Foreign Application Priority Data
Jun. 20, 2005 (KR) 10-2005-0052855

(51) Int. Cl. G09G 3/36

(52) U.S. Cl. 345/102

(57) ABSTRACT

A brightness enhancement film a includes a main body for reflecting and polarizing light, a protection layer disposed on the main body, and an adhesive layer disposed between the main body and the protection layer and containing a photo-curable resin, a photo-initiator, and a radical scavenger.

### CROSS-REFERENCE TO RELATED APPLICATION

This application claims priority to and the benefit of Korean Patent Application No. 10-2005-0052855 filed in the Korean Intellectual Property Office on Jun. 20, 2005, the entire contents of which are incorporated herein by reference.

### FIELD OF THE INVENTION

The present invention relates a liquid crystal display and a brightness enhancement film therefor.

### DESCRIPTION OF THE RELATED ART

Generally, a liquid crystal display (LCD) includes a thin film transistor (TFT) array panel, a common electrode panel, and liquid crystal layer interposed between these panels. The TFT array panel includes a plurality of pixel electrodes, a plurality of TFTs, a plurality of gate lines, and a plurality of data lines. The common electrode panel includes a common electrode and a plurality of color filters.

In the LCD, liquid crystal molecules in the liquid crystal layer are rotated by an electric field formed between the pixel electrode and the common electrode, and light transmittance changes depending on the rotation angle of the liquid crystal to display a desired image. The electric field is controlled by the voltage of the pixel electrode, and the voltage of the pixel electrode is transmitted by a switching element such as a TFT. The TFT transmits the data signal transmitted through the data line to the pixel electrode or blocks the data signal in response to a scanning signal transmitted through the gate line.

When no electric field is applied, the liquid crystal molecules are aligned by alignment layers disposed on the surfaces of the TFT array panel and the common electrode panel, otherwise the liquid crystal molecules are rotated parallel to or perpendicular to the direction of the electric field.

The LCD is a non-emissive display device, and thus a light from a separate light source is supplied to the LCD either externally or internally. Generally, a separate backlight unit is provided at the rear side of the TFT array panel. The backlight unit includes a lamp for supplying the light, a light guide plate for uniformly distributing the light to the panel, and various films.

The LCD may not wholly transmit the light supplied from the backlight, thus it is important to increase the brightness of the panels. To increase the brightness of the panels, various films such as a brightness enhancement film disposed between the back light unit and the panel are being developed.

The brightness enhancement film includes a main body for enhancing the brightness, a protection layer for protecting the main body, and adhesives for adhering the main body and the protection layer together.

However, the adhesives included in the brightness enhancement film becomes easily yellowish by ultraviolet (UV) light supplied from the backlight assembly. Yellowing shortens the useful life of large liquid crystal devices.

### SUMMARY OF THE INVENTION

A brightness enhancement film according to an embodiment of the present invention includes a main body for reflecting and polarizing light, a protection layer disposed on the main body, and an adhesive layer disposed between the main body and the protection layer and including a photo-curable resin, a photo-initiator, and a radical scavenger selected from one or more of a benzotriazole compound, a benzophenol compound, a cyanoacrylate compound, and a hindered amine light stabilizer (HALS). Butyl-4-hydroxyanisole is an exemplary radical scavenger and polycarbonate is an exemplary protection layer.

The photo-initiator may include at least one selected from (1-hydroxycyclohexyl)phenyl-methanone, 2,2-dimethoxy-2-phenylacetophenone, bis(2,4,6-trimethylbenzoyl) phenylphosphineoxide, and 2-methyl-1-(4-methylthiophenyl)-2-morpholinepropane-1-on.

The content of the photo-initiator may be about 100 ppm to about 10,000 ppm relative to the content of the photo-curable resin. The adhesive layer may further include an adhesion promoter, a stabilizer, and a filler.

An LCD according to an embodiment of the present invention preferably includes an panel assembly for displaying an image, and a backlight assembly for supplying light to the panel assembly. The backlight assembly may include a lamp, a reflecting sheet disposed under the lamp, and a brightness enhancement film disposed above the lamp. The brightness enhancement film may include a main body for reflecting and polarizing light, a protection layer disposed on the main body, and an adhesive layer between the main body and the protection layer and containing a photo-curable resin, a photo-initiator, and a radical scavenger.

The panel assembly may include a thin film transistor (TFT) array panel including a plurality of TFTs, a common electrode panel positioned opposite to the TFT array panel and including a common electrode, and a liquid crystal layer interposed between the LCD panel and the common electrode panel. The LCD may further include polarizers disposed on outer surfaces of the TFT array panel and the common electrode panel.

### BRIEF DESCRIPTION OF THE DRAWINGS

The present invention will become more apparent by describing embodiments thereof in detail with reference to the accompanying drawings, in which:

FIG. 1 is an exploded perspective view of an LCD according to an exemplary embodiment of the present invention;

FIG. 2 is a sectional view representing the position of films of the backlight assembly according to an exemplary embodiment of the present invention;

FIG. 3 is a mimetic diagram representing the optical principles of a brightness enhancement film; and

FIG. 4 is a sectional view of the brightness enhancement film according to an exemplary embodiment of the present invention.

### DETAILED DESCRIPTION OF THE EMBODIMENTS

Preferred embodiments of the present invention will be described more fully hereinafter with reference to the accompanying drawings, in which preferred embodiments of the invention are shown. To clarify multiple layers and regions, the thicknesses of the layers are enlarged in the drawings. Like reference numerals designate like elements throughout the specification.

It will be understood that when an element such as a layer, film, region, or substrate is referred to as being “on” another element, it can be directly on the other element or intervening elements may also be present.

On the other hand, if any part is said to be positioned directly on another part it means that there is no intermediate part between the two parts.

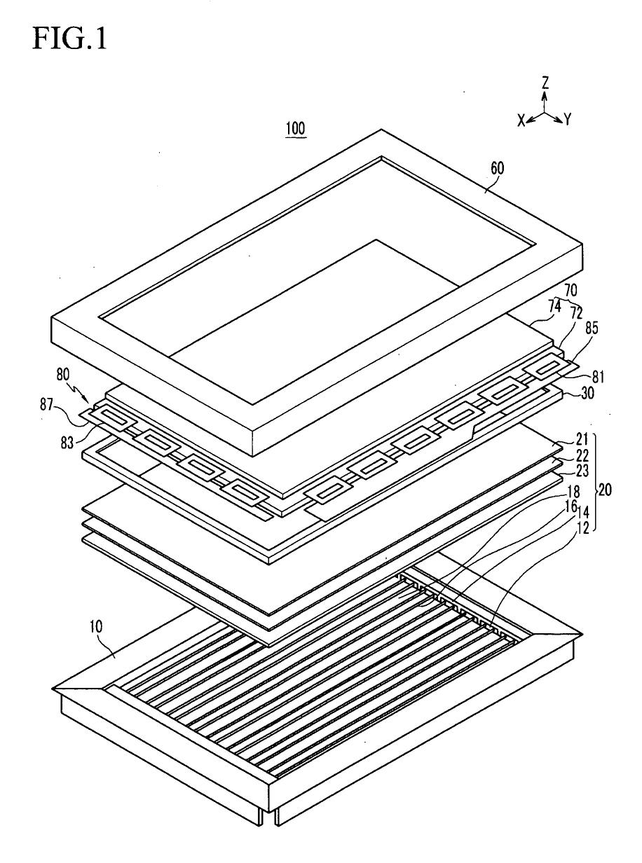

FIG. 1 is an exploded perspective view of an LCD according to an exemplary embodiment of the present invention. LCD 100 includes a direct-lighting type backlight assembly 20 for supplying light, and an LCD panel assembly 80 for displaying images, a top chassis 60, a mold frame 30, and a bottom chassis 10 for fixing and supporting backlight assembly 20 and the LCD panel assembly 80. Backlight assembly 20 supplies and guides the light to the LCD panel assembly 80 and enhances the brightness of the light.

The LCD panel assembly 80 includes LCD panels 70, tape carrier packages (TCPs) 81 and 83, and printed circuit boards (PCBs) 85 and 87. LCD panels 70 include a thin film transistor (TFT) array panel 72 and a common electrode panel 74 positioned opposite to TFT array panel 72 with a liquid crystal layer(not shown) interposed between these panels 72 and 74.

TFT array panel 72 includes a plurality of thin film transistors (not shown) arranged in a matrix shape. Each of the TFTs has a gate terminal connected to a gate line (not shown), a source terminal connected to a data line (not shown), and a drain terminal connected to a pixel electrode (not shown). The pixel electrode includes transparent conductive material such as indium tin oxide (ITO) and indium zinc oxide (IZO).

Electrical signals are input to the gate lines and the data lines from PCBs 85 and 87, and transmitted to the gate terminals and the source terminals of the TFTs, thereby turning on or turning off the TFTs to output electrical signals to the pixel electrodes through the drain terminals of the TFTs.

Common electrode panel 74 includes red, green, and blue color filters (not shown), and a common electrode (not shown). The color filters are provided for color display and formed by thin film forming processes. The common electrode is made of transparent material such as ITO and IZO and covers the entire surface of common electrode panel 74. The common electrode is supplied with a common voltage. An electric field is formed in the liquid crystal layer between a pixel electrode and the common electrode. The electric field changes tilt angles of liquid crystal molecules, which in turn changes light transmittance to display an image.

In order to control the tilt angle of the liquid crystal molecules and the time to change the tilt angle, gate signals and data signals are applied to the gate lines and the data lines of TFT array panel 72.

Data TCP 81, attached to an edge portion of LCD panels, 70 applies the data signals and gate TCP 83, attached to another edge portion of the LCD panels 70, applies the gate signals. Data TCP 81 and gate TCP 83 are respectively connected to data PCB 85 and gate PCB 87. Data PCB 85 and gate PCB 87 receive image signals from outside of the LCD 100 and apply the signals to the data lines and the gate lines. Data PCB 85 and gate PCB 87 generate the control signals for driving the LCD 100 and output the control signals to gate TCP 83 and data TCP 81.

Backlight assembly 20 supplies light uniformly to the LCD panel assembly 80.

Backlight assembly 20 is received and fixed in bottom chassis 10. Backlight assembly 20 includes lamps 16, a reflecting sheet 18, lamp holders 12, mold frame sides 14, a brightness enhancement film 21, a prism sheet 22, and a diffusing plate 23. Lamps 16 are disposed on bottom chassis 10 in parallel at predetermined intervals. Reflecting sheet 18 is disposed under lamps 16, and covers an entire inner surface of bottom chassis 10. Reflecting sheet 18 reflects the light emitted from lamp 16. Lamp holders 12 are provided near the ends of lamps 16, thereby fixing lamps 16. Mold frame sides 14 fix lamp holders 12. Brightness enhancement film 21, the prism sheet 22, and the diffusing plate 23 enhance the brightness characteristic of the light.

An inverter board (not shown) and a PCB for converting signals (not shown) may be mounted on the rear surface of bottom chassis 10. The inverter board may be a PCB for supplying electric power. The inverter board transforms an external voltage into a predetermined voltage level and applies the transformed voltage to lamps 16. The PCB for converting signals is connected to data PCB 85 and gate PCB 87, and converts analog image signals into digital image signals and then supplies the digital data signals to the LCD panel assembly 80.

Top chassis 60 bends the TCPs 81 and 83 to place data PCB 85 and gate PCB 87 at the outer sides of mold frame 30 and fixes the LCD panel assembly 80 on bottom chassis 10. A front case and a rear case (not shown in FIG. 1) may be disposed on the top chassis 60 and under bottom chassis 10, respectively, and these are assembled into the LCD 100.

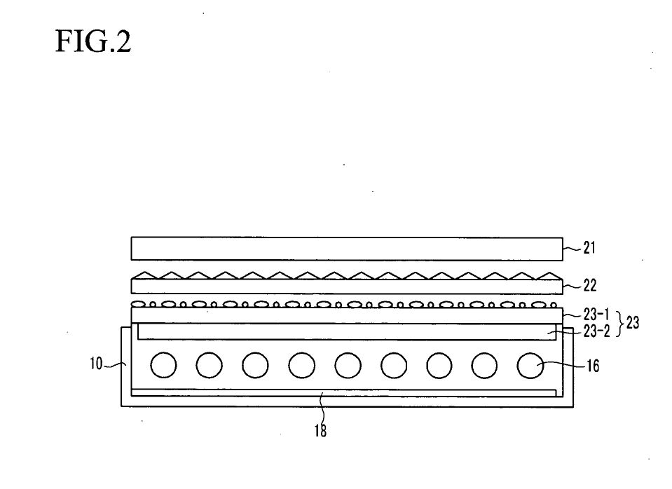

FIG. 2 is a sectional view representing the position of films in the backlight assembly according to an exemplary embodiment of the present invention. As shown in FIG. 2, the backlight assembly includes a reflecting sheet 18 disposed at the bottom side of bottom chassis 10 and lamp 16 disposed thereon. A diffusing sheet 23-1 and a diffusing plate 23-2 are disposed on lamp 16. The diffusing sheet 23-1 and the diffusing plate 23-2 diffuse the light emitted from lamp 16 and supply the light uniformly to the entire area of the LCD panel assembly 80. A prism sheet 22 is disposed on diffusing sheet 23-1, and a brightness enhancement film 21 is disposed on prism sheet 22. Prism sheet 22 and brightness enhancement film 21 enhance the brightness of the display device.

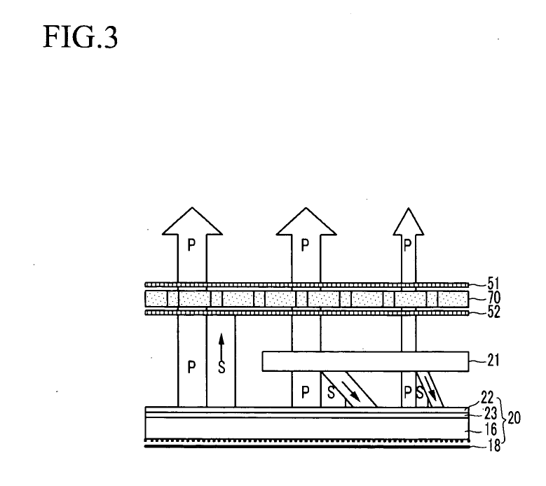

FIG. 3 is a schematic diagram representing the optical principles of the brightness enhancement film. As shown in FIG. 3, a prism sheet 22, a diffusing sheet 23, a lamp 16, and a reflecting sheet 18 are disposed under brightness enhancement film 21. An LCD panel 70 is disposed above brightness enhancement film 21, and polarizers 51 and 52 are respectively attached to the upper surface and the lower surface of the LCD panel 70.

P waves are passed through brightness enhancement film 21, and S waves are reflected by film 21. The S wave, reflected by film 21, is reflected again by reflecting sheet 18 and re-directed to brightness enhancement film 21. Part of the re-directed S wave is polarized to the P wave, and thus passes through brightness enhancement film 21. The brightness of the display device is improved by repeating the procedure described above.

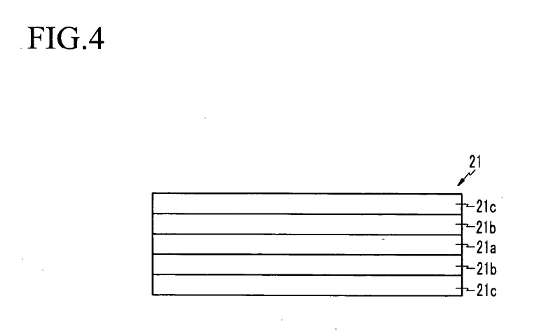

The brightness enhancement film according to an embodiment of the present invention will be described in detail with reference to FIG. 4.

FIG. 4 is a sectional view of the brightness enhancement film according to an embodiment of the present invention.

Brightness enhancement film 21 includes a main body 21a, a pair of protection layers 21c, and a pair of adhesive layers 21b. The main body 21a is interposed between the protection layers 21c of the main body 21a, and the adhesive layers 21b adhere the protection layers 21c to the main body 21a. However, the brightness enhancement film according to the invention is not limited thereto, and thus may further include other layers as well. As an example, a dual brightness enhancement film (DBEF) or a diffusive reflective polarization film (DRPF) can be used as the main body 21a. Protection layer 21c protects the main body 21a and may be made of material such as a polycarbonate. The adhesive layer 21b may be UV curable adhesives. Adhesive layer 21b includes a photo-curable resin, a photo-initiator, a radical scavenger, and so on.

Photo-curable resins are compounds that can harden by exposure to a specific wavelength of light such as UV rays, for example, a polymer resin which is polymerized by the photo-curing reaction of a monomer such as oxirane, bisphenol A, an isocyanate monomer, or an oligomer, such as an epoxy resin, an acrylic resin, a polyester resin, and a polyurethane resin.

When a photo-initiator is subjected to UV rays, it produces radicals that react with a monomer or oligomer to be polymerized. The photo-initiator having an absorption band of UV, 250 to 450 nm may include one or more of a carbonyl compound, an azo compound, a sulfur compound, and so on. An exemplary photo-initiator may be a compound selected from the group consisting of (1-hydroxycyclohexyl)phenyl-methanone, 2,2-dimethoxy-2-phenylacetophenone, bis(2,4,6-trimethylbenzoyl)phenylphosphineoxide, and 2-methyl-1-(4-methylthiophenyl)-2-morpholinepropane-1-on. The photo-initiator concentration may range from about 100 to 10,000 ppm relative to the amount of photo-curable resin. The photo-initiator mainly affects the efficiency of the photo-curable adhesives.

Adhesive 21b advantageously includes a radical scavenger that can remove radicals. The radical scavenger may advantageously be one selected from the group consisting of a benzotriazole compound, a benzophenol compound, a cyanoacrylate compound, and a hindered amine light stabilizer (HALS). An exemplary radical scavenger is butyl-4-hydroxyanisole.

The radical scavenger combines with hydroperoxide radicals produced by combination of the photo-initiator with oxygen when the photo-initiator is exposed to light for a long time. Polymer radicals are produced by decomposition of the polymer resin included in the adhesives when attacked by the hydroperoxide radical. Decomposition of the polymer resin gives rise to “yellowing”. Yellowing shortens the useful lifetime of an LCD. The radical scavenger combines with polymer radicals having already formed and eliminates them. Accordingly, the above-described adhesive 21b of brightness enhancement film 21 can reduce the degradation rate of the photo-initiator and the yellowing.

Adhesive 21b may further include an adhesion promoter, a photo-stabilizer, or a filler in addition to the photo-curable resin, the photo-initiator, and the radical scavenger.

As described above, the adhesives of brightness enhancement film according to the invention includes the radical scavenger to reduce yellowing, thereby prolonging the lifetime and improving the characteristics of the LCD.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A brightness enhancement film for an LCD comprising:
a main body reflecting and polarizing light;
a protection layer disposed on the main body; and
an adhesive layer disposed between the main body and the protection layer and comprising a photo-curable resin, a photo-initiator, and a radical scavenger.

2. The brightness enhancement film of claim 1, wherein the radical scavenger comprises at least one selected from the group consisting of a benzotriazole compound, a benzophenol compound, a cyanoacrylate compound, and a hindered amine light stabilizer (HALS).

3. The brightness enhancement film of claim 1, wherein the radical scavenger comprises butyl-4-hydroxyanisole.

4. The brightness enhancement film of claim 1, wherein the protection layer comprises a polycarbonate.

5. The brightness enhancement film of claim 1, wherein the photo-initiator comprises at least one selected from the group consisting of (1-hydroxycyclohexyl)phenyl-methanone, 2,2-dimethoxy-2-phenylacetophenone, bis(2,4,6-trimethylbenzoyl)phenylphosphineoxide, and 2-methyl-1-(4-methylthiophenyl)-2-morpholinepropane-1-on.

6. The brightness enhancement film of claim 1, wherein the content of the photo-initiator is about 100 ppm to about 10,000 ppm relative to the content of the photo-curable resin.

7. The brightness enhancement film of claim 1, wherein the adhesive layer further comprises one or more of an adhesion promoter, a photo-stabilizer, and a filler.

8. A liquid crystal display device comprising:
an panel assembly displaying an image; and
a backlight assembly supplying light to the panel assembly, wherein the backlight assembly comprises a lamp, a reflecting sheet disposed under the lamp, and a brightness enhancement film disposed above the lamp, said brightness enhancement film comprises a main body reflecting and polarizing light, a protection layer disposed on the main body, and an adhesive layer disposed between the main body and the protection layer and comprising a photo-curable resin, a photo-initiator, and a radical scavenger.

9. The liquid crystal display device of claim 8, wherein the radical scavenger comprises one or more of a benzotriazole compound, a benzophenol compound, a cyanoacrylate compound and a hindered amine light stabilizer (HALS).

10. The liquid crystal display device of claim 9, wherein the radical scavenger comprises butyl-4-hydroxyanisole.

11. The liquid crystal display device of claim 8, wherein the panel assembly comprises a thin film transistor (TFT) array panel comprising a plurality of TFTs, a common electrode panel positioned opposite to the TFT array panel and comprising a common electrode, and a liquid crystal layer interposed between the LCD panel and the common electrode panel.

12. The liquid crystal display device of claim 11, further comprising polarizers disposed on outer surfaces of the TFT array panel and the common electrode panel.
